(19) United States
(12) Patent Application Publication
(10) Pub. No.: US 2007/0127116 A1
(43) Pub. Date: Jun. 7, 2007

(54) ARRANGEMENT FOR FOCUSING ILLUMINATION DEVICES FOR MICROSCOPES

(75) Inventors: PETER DIETRICH, Oberkochen (DE); Cornelia Bendlin, Goettingen (DE); Andreas Hermann, Gleichen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Carl Zeiss Microlmaging GmbH

(21) Appl. No.: 11/566,078

(22) Filed: Dec. 1, 2006

(30) Foreign Application Priority Data
Dec. 1, 2005 (DE) 10 2005 058 187.0

(51) Int. Cl. G02B 21/00

(52) U.S. Cl. 359/383; 359/368

(57) ABSTRACT

The subject matter of the invention is an arrangement for focusing and adjusting illumination devices at microscopes which comprises a stationary stage and a housing or a stand with a stand base. A condenser carrier is arranged at the stand base so as to be removable and carries a condenser holder which is mounted so as to be displaceable in direction of the optical axis of the microscope beam path and at which a condenser is arranged. Further, a device is provided at the condenser holder for exchanging and adjusting the condenser. According to the invention, the condenser carrier is arranged between the observer and the optical axis of the microscope beam path in the area of the stand base adjacent to (facing) the observer.

### CROSS-REFERENCE TO RELATED APPLICATION

This application claims priority of German Application No. 10 2005 058 187.0, filed Dec. 1, 2005, the complete disclosure of which is hereby incorporated by reference.

### BACKGROUND OF THE INVENTION

a) Field of the Invention

The invention is directed to an arrangement for focusing illumination devices for microscopes and particularly for fixed stage microscopes with a stationary, immovable stage.

b) Description of the Related Art

Arrangements for focusing comprise primarily condenser carriers with operator controls in the form of focusing knobs and adjusting knobs for displacing the condensers in direction of the optical axis of the microscope beam path (Z-direction) and are usually arranged in or at the bottom part of the microscope stand in or at the stand base in order to realize transmitted illumination of the objects to be observed. Further, these operator controls are arranged in the rear area, that is, in an area of the stand base which is remote from the observer and is unfavorable with respect to ergonomics. Therefore, it is possible to change condensers only with increased effort and reduced accessibility.

These disadvantages occur particularly in fixed stage microscopes in which the object to be examined is arranged on a stationary, immovable stage and the focusing process is carried out by means of an independent movement of the objective and condenser. In these microscopes, the size of the stage surface is dimensioned in such a way that manipulators can also be employed in this area. The entire lower region of the microscope stand and therefore also the stand base are covered by the stage and are poorly accessible.

U.S. Pat. No. 5,870,222 describes a microscope in which the stage is arranged so as to be fixed at the stand. A condenser arrangement which is displaceable in direction of the optical axis of the microscope beam path is located beneath the stage, its operator controls arc located at an ergonomically unfavorable location remote from the observer and are poorly accessible.

U.S. Pat. No. 6,437,912 describes a microscope with a transmitted light condenser in which the condenser is arranged on a slide and can be displaced in direction of the optical axis of the microscope beam path for purposes of adjustment. In this case also, the operator controls which are provided for displacement (adjustment) are in an ergonomically unfavorable area of the stand base remote from the observer.

### OBJECT AND SUMMARY OF THE INVENTION

Therefore, it is the primary object of the invention to provide an arrangement for focusing and adjusting illumination devices in microscopes which overcomes the disadvantages of the prior art and provides an ergonomically favorable and easily accessible arrangement of the operator controls.

According to the invention, this object is met in an arrangement constructed according to the invention for focusing and adjusting illumination devices at microscopes with a stationary stage and a housing or a stand with a stand base which comprises a condenser carrier which is arranged at the stand base, a condenser holder which is mounted at the condenser carrier so as to be displaceable in direction of the optical axis of the microscope beam path and at which a condenser is arranged, and means at the condenser holder for exchanging and adjusting the condenser. The condenser carrier is arranged between the observer and the optical axis of the microscope beam path in the area of the stand base adjacent to and/or facing the observer.

In order to ensure an ergonomically favorable and unhindered operation and adjustment of the condenser at all times, adjusting means, advantageously in the form of control knobs, are advantageously provided at the condenser carrier for adjusting the condenser in direction of the optical axis of the microscope beam path and are arranged at a structural component part of the condenser carrier that faces the observer.

It is further advantageous when the condenser carrier is arranged at the stand base so as to be removable from the front. This makes it possible to change the condenser easily or to observe objects in incident illumination when the condenser is removed.

The invention will be described more fully in the following with reference to an embodiment example shown in the drawing.

### BRIEF DESCRIPTION OF THE DRAWING

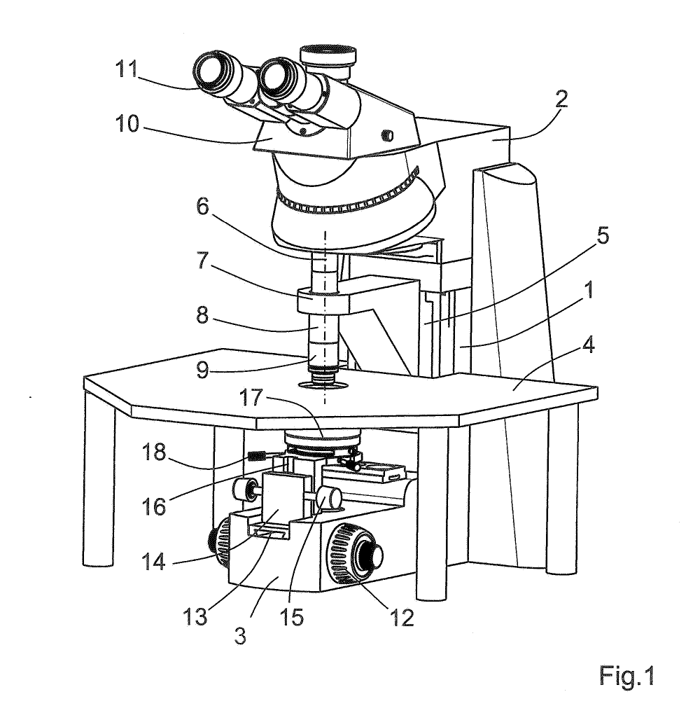

The sole drawing, FIG. 1, is a pictorial view of the arrangement for focusing and adjusting illumination shown in conjunction with a microscope and stand.

### DESCRIPTION OF THE PREFERRED EMBODIMENTS

The microscope that is shown by way of example in FIG. 1 comprises a housing or stand 1 with a stand head 2, a stand base 3 which is provided at the bottom, and a stationary, immovable stage 4 on which the object to be observed or examined and/or also manipulators are/is arranged. An objective slide 7 which is mounted in a guide 5 and is displaceable in direction of the optical axis 6 of the microscope beam path is located at the middle part of the stand 1, and a receptacle 8 with a microscope objective 9 is arranged at this objective slide 7. An eyepiece carrier 10 with one or more eyepieces 11 is arranged at the stand head 2.

Operator controls 12 in the form of rotary knobs, for example, are located at the stand base 3 for focusing the microscope objective 9. Also provided at the stand base 3 is a condenser carrier 14 which is advantageously guided in a dovetail guide 13 and which is removable from the stand base 3. A condenser holder 16 carrying the condenser 17 of the illumination device is arranged at the condenser carrier 14 and is displaceable in direction of the optical axis 6 (Z-direction) by means of operator controls 15. This also ensures that the condenser carrier 14, together with the condenser holder 16 and the condenser 17, can be removed from the stand base 3 in a simple manner, which is necessary when observing the object with incident illumination.

The condenser 17 is advantageously mounted in the condenser holder 16 so as to be adjustable in two coordinates perpendicular to the optical axis 6 by means of adjusting screws 18. In order to ensure an ergonomically favorable and unimpeded adjustment of the condenser 17 for purposes of focusing and adjusting the condenser 17 at any time, the condenser carrier 14 and the operator controls 15 for displacing the condenser holder 16 in direction of the optical axis 6 of the microscope beam path are arranged at the side of the stand base 3 adjacent to the observer between the observer and the optical axis 6 of the beam path. In this way, operation of the operator controls 15 and adjusting screws 18 is not impeded by the stage 4, which is not ensured in the arrangements according to the prior art.

While the foregoing description and drawing represent the present invention, it will be obvious to those skilled in the art that various changes may be made therein without departing from the true spirit and scope of the present invention.

### REFERENCE NUMBERS

1 stand
2 stand head
3 stand base
4 stage
5 guide
6 optical axis
7 objective slide
8 receptacle
9 microscope objective
10 eyepiece carrier
11 eyepiece
12 operator control
13 dovetail guide
14 condenser carrier
15 operator control
16 condenser holder
17 condenser
18 adjusting screw

What is claimed is:

1. An arrangement for focusing and adjusting illumination devices at microscopes with a stationary stage and a housing or a stand with a stand base, comprising:
a condenser carrier which is arranged at the stand base;
a condenser holder which is mounted at the condenser carrier so as to be displaceable in direction of the optical axis of the microscope beam path and at which a condenser is arranged; and
means at the condenser holder for exchanging and adjusting the condenser;
said condenser carrier being arranged between the observer and the optical axis of the microscope beam path in the area of the stand base adjacent to and/or facing the observer.

2. The arrangement according to claim 1, wherein adjusting means or control means for adjusting the condenser in the direction of the optical axis of the microscope beam path are provided at the condenser carrier and are arranged at a structural component part of the condenser carrier facing the observer.

3. The arrangement according to claim 1, wherein the condenser carrier is arranged at the stand base so as to be removable from the side of the observer.
